(19) United States
(12) Patent Application Publication
(10) Pub. No.: US 2025/0173353 A1
(43) Pub. Date: May 29, 2025

(54) SYSTEM FOR GENERATING AN ELECTRONIC DATA FABRIC USING VIRTUALIZED PHOTOCROSSLINKING-BASED PARALLEL COMPUTING PROCESS

(71) Applicant: BANK OF AMERICA CORPORATION, Charlotte, NC (US)

(72) Inventors: Nimish Ravindra Deshpande, Mumbai (IN); Mani Arora, Gurgaon (IN); Ankit Upadhyaya, Gurugram (IN); Prashant Anna Bidkar, Shakarpur (IN); Roshan Miranda, Palghar Maharashtra (IN)

(73) Assignee: BANK OF AMERICA CORPORATION, Charlotte, NC (US)

(21) Appl. No.: 18/523,049

(22) Filed: Nov. 29, 2023

(51) Int. Cl. G06F 16/26; G06N 3/123

(52) U.S. Cl. CPC G06F 16/26; G06N 3/123

(57) ABSTRACT

A system is provided for generating an electronic data fabric using virtualized photocrosslinking-based parallel computing process. In particular, the system may, using an artificial intelligence (“AI”) model, identify one or more users and a subject or description of a communication in order to determine the data needs of the one or more users, where such data may reside within one or more databases, websites, applications, tools, and/or the like. The system may then use a simulated photocrosslinking based process to assimilate various combinations of datasets and place the data sets within a virtualized environment. The virtualized data may then be linked to a data fabric to identify the linkages and/or sublinkages between the virtualized data and the underlying data. Subsequently, upon receiving a data request from a user, the system may use the metadata within the data fabric to dynamically recall the relevant data in real time.

### TECHNOLOGICAL FIELD

Example embodiments of the present disclosure relate to a system for generating an electronic data fabric using virtualized photocrosslinking-based parallel computing process.

### BACKGROUND

There is a need for an efficient way to identify and provision relevant data on a real-time, time-sensitive basis.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for generating an electronic data fabric using virtualized photocrosslinking-based parallel computing process. In particular, the system may, using an artificial intelligence (“AI”) model, identify one or more users and a subject or description of a communication in order to determine the data needs of the one or more users, where such data may reside within one or more databases, websites, applications, tools, and/or the like. The system may then use a simulated photocrosslinking based process to assimilate various combinations of datasets and place the data sets within a virtualized environment. The virtualized data may then be linked to a data fabric to identify the linkages and/or sublinkages between the virtualized data and the underlying data. Subsequently, upon receiving a data request from a user, the system may use the metadata within the data fabric to dynamically recall the relevant data in real time. In this way, the system may provide a more efficient way to serve the data needs of users.

Accordingly, embodiments of the present disclosure provide a system for generating an electronic data fabric using virtualized photocrosslinking-based parallel computing process, the system comprising a processing device; a non-transitory storage device containing instructions when executed by the processing device, causes the processing device to perform the steps of identifying, based on a user input, one or more users and a subject associated with the one or more users; determining one or more data requirements of the one or more users by analyzing, using an artificial intelligence (“AI”) algorithm, the one or more users and the subject associated with the one or more users; generating cross-linkages within a DNA database comprising target data; generating a data virtualization layer comprising the target data; generating a data fabric comprising metadata associated with the target data and the cross-linkages; receiving a data request, from a user from the one or more users, for a first data configuration including the target data; and presenting the first data configuration on a user computing device of the user by using the metadata within the data fabric to retrieve the target data within the data virtualization layer.

In some embodiments, generating the cross-linkages comprises generating a stream of photons using an antenna, wherein the stream of photons simulate the one or more data requirements.

In some embodiments, generating the stream of photons comprises modulating a frequency of the photons emitted from the antenna to encode the data requirements into the stream of photons.

In some embodiments, the AI algorithm comprises a natural language processing based algorithm that uses k-means clustering to identify keywords associated with the one or more users and the subject associated with the one or more users.

In some embodiments, the user input comprises a request to initiate a networked conference including the one or more users.

In some embodiments, the request to initiate the networked conference comprises a description of a purpose of the conference, wherein determining the data requirements further comprises using the AI algorithm to analyze the description of the purpose of the conference.

In some embodiments, the first data configuration comprises at least one of a chart, graph, table, or list generated based on the target data.

Embodiments of the present disclosure also provide a computer program product for generating an electronic data fabric using virtualized photocrosslinking-based parallel computing process, the computer program product comprising a non-transitory computer-readable medium comprising code causing an apparatus to perform the steps of identifying, based on a user input, one or more users and a subject associated with the one or more users; determining one or more data requirements of the one or more users by analyzing, using an artificial intelligence (“AI”) algorithm, the one or more users and the subject associated with the one or more users; generating cross-linkages within a DNA database comprising target data; generating a data virtualization layer comprising the target data; generating a data fabric comprising metadata associated with the target data and the cross-linkages; receiving a data request, from a user from the one or more users, for a first data configuration including the target data; and presenting the first data configuration on a user computing device of the user by using the metadata within the data fabric to retrieve the target data within the data virtualization layer.

In some embodiments, generating the cross-linkages comprises generating a stream of photons using an antenna, wherein the stream of photons simulate the one or more data requirements.

In some embodiments, generating the stream of photons comprises modulating a frequency of the photons emitted from the antenna to encode the data requirements into the stream of photons.

In some embodiments, the AI algorithm comprises a natural language processing based algorithm that uses k-means clustering to identify keywords associated with the one or more users and the subject associated with the one or more users.

In some embodiments, the user input comprises a request to initiate a networked conference including the one or more users.

In some embodiments, the request to initiate the networked conference comprises a description of a purpose of the conference, wherein determining the data requirements further comprises using the AI algorithm to analyze the description of the purpose of the conference.

Embodiments of the present disclosure also provide a computer-implemented method for generating an electronic data fabric using virtualized photocrosslinking-based parallel computing process, the computer-implemented method comprising identifying, based on a user input, one or more users and a subject associated with the one or more users; determining one or more data requirements of the one or more users by analyzing, using an artificial intelligence (“AI”) algorithm, the one or more users and the subject associated with the one or more users; generating cross-linkages within a DNA database comprising target data; generating a data virtualization layer comprising the target data; generating a data fabric comprising metadata associated with the target data and the cross-linkages; receiving a data request, from a user from the one or more users, for a first data configuration including the target data; and presenting the first data configuration on a user computing device of the user by using the metadata within the data fabric to retrieve the target data within the data virtualization layer.

In some embodiments, generating the cross-linkages comprises generating a stream of photons using an antenna, wherein the stream of photons simulate the one or more data requirements.

In some embodiments, generating the stream of photons comprises modulating a frequency of the photons emitted from the antenna to encode the data requirements into the stream of photons.

In some embodiments, the AI algorithm comprises a natural language processing based algorithm that uses k-means clustering to identify keywords associated with the one or more users and the subject associated with the one or more users.

In some embodiments, the user input comprises a request to initiate a networked conference including the one or more users.

In some embodiments, the request to initiate the networked conference comprises a description of a purpose of the conference, wherein determining the data requirements further comprises using the AI algorithm to analyze the description of the purpose of the conference.

In some embodiments, the first data configuration comprises at least one of a chart, graph, table, or list generated based on the target data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for generating an electronic data fabric using virtualized photocrosslinking-based parallel computing process, in accordance with an embodiment of the disclosure;

FIG. 2 illustrates an exemplary machine learning subsystem architecture, in accordance with an embodiment of the invention;

FIG. 3 illustrates a method for generating an electronic data fabric using virtualized photocrosslinking-based parallel computing process, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

As used herein, “DNA computing” may refer to an alternative paradigm to conventional computing that expresses units of data as one of four deoxyribonucleic acid (“DNA”) bases (e.g., adenine, guanine, thymine, and cytosine) rather than binary digits (e.g., 0 or 1). By using a combination of the DNA bases, the system may be able to express various types of data. Furthermore, by carrying out algorithmic processes on the DNA structure (e.g., by carrying out operations such as sorting, truncating, splitting, appending, and/or the like), the system may perform computations. DNA computing may provide a number of significant advantages over conventional computing, such as the ability to perform operations in a substantially parallel manner, which allows complex computations and mathematical problems to be solved in a drastically reduced amount of time.

As used herein, “virtualized photocrosslinking” or “simulated photocrosslinking” may refer to a process by which linkages and/or sublinkages may be created within a dataset of a DNA database (e.g., data that is stored according to the DNA based structure described above). In this regard, the dataset may be placed into a virtualized environment and may be virtually “excited” or “activated” by UV light such that certain bases within the dataset become reactive, thereby forming covalent bonds with nearby functional groups within the dataset.

In today's world, there is a need for users to make timely decisions based on receiving the correct data in the correct format as quickly as possible. That said, there are several challenges that may prevent such users from accessing the necessary data. For instance, the available data may only be presented in certain formats and/or pre-determined perspectives that may not be optimal for the desired purpose. Furthermore, the users may not be aware exactly where the necessary data resides or what computations went into the data as presented. Finally, certain users may not have access to certain portions of the underlying data, which may prevent the user from gaining insights into how the data was derived. Accordingly, there is a need for a more efficient way to serve the data needs of such users.

To address the above concerns among others, the system described herein provides a way to serve data to users in various relevant perspectives in real time using an electronic data fabric using virtualized photocrosslinking-based parallel computing process. In this regard, the system may receive a list of users, a subject, and/or a purpose description associated with a group communication (or “conference metadata”). For instance, such information may be generated when a user creates a teleconference meeting or room (e.g., a videoconference meeting). The system may analyze the use an AI algorithm (e.g., a k-means clustering algorithm) to analyze the conference metadata to identify the keywords associated with the data requirements according to the users, the subject, and desired outcome of the conference. Based on the keywords, the system may be able to identify what types of data the users may require over the course of the conference.

The data that may potentially be required by the users may reside in a variety of databases, websites, applications, tools, and/or the like. In this regard, the data may be stored within a DNA database (e.g., a database within a DNA computing based environment). Once the data requirements of the users have been identified, the system may then translate the data requirements into photons using an antenna, where the frequency of the photons may be dependent and/or based on the data requirements. The photons may then be emitted to the DNA database, thereby generating cross-linkages within the data sets of the DNA database. In this regard, UV radiation my activate the bases within the dataset, which excites the bases into a highly reactive intermediate form, thereby causing the bases to form covalent bonds with other bases within the chain. The frequency of the photons may in turn change which bases are excited and what crosslinkages are formed within the DNA data structure.

Upon creating the cross-linkages, the system may assimilate multiple combinations of data from the datasets and logically layer the data within a virtual environment (e.g., a data virtualization layer) according to the data requirements and/or preferences as determined by the AI model. Based on the linkages, the system may generate a data fabric that comprises metadata regarding the various linkages between the data within the data sets. Using the metadata within the data fabric, the system may generate, in real time, various perspectives or views of the data (e.g., charts, tables, summaries, graphs, raw data figures, and/or the like) during the course of the interactions between the users.

Subsequently, the system may receive a query from one of the users for a particular piece of data or data set to be displayed from a particular perspective or view. In such an embodiment, the system may use the metadata within the data fabric and the virtualized data within the virtualized data layer to delegate the queries to the source databases to retrieve the necessary data and format the data in the manner requested in the user's query. In some embodiments, the system may further receive a query to display a certain data set from a different perspective, or there may be changes in the data requirements through the course of the interactions. Upon receiving the query or detecting a change in the data requirements, the system may virtualize the data in real time according to the query or change in data requirements using the data layer and virtualized data layer.

In some embodiments, certain users may be assigned different data permissions with respect to the underlying data. Accordingly, the system may, using the AI model, determine which data and which perspectives of the data that each user is authorized to access. For instance, in some cases, the system may allow a user to access certain perspectives or final outputs based on certain types of data without allowing the user to access the underlying data itself. In this way, the system may provide a fine-tuned control over the types of data that a user is allowed to access without preventing the users from accessing the insights based on such data.

Once the system detects that the data requirement has been satisfied (e.g., the conference has concluded), the system may automatically delete the data virtualization layer and the data fabric. In some embodiments, the system may allow users to download and save relevant perspectives of the data for future use.

An exemplary embodiment is provided as follows. It should be understood that the following embodiment is provided for illustrative purposes only and is not intended to restrict the scope of the disclosure provided herein. In one embodiment, a user such as a systems administrator may initiate a video conference with other administrators to discuss the components of an entity's computing environment that cause the largest drain on computing resources. In this regard, the user may input a subject line (e.g., “Meeting to discuss optimization of resources”) and a description of the purpose of the meeting (e.g., “To streamline processes and reduce computational overhead of network environment”). Upon creation of the conference, the system may use a natural language processing AI algorithm (e.g., a k-means clustering algorithm) to identify the keywords in the various fields associated with the conference to identify the users who are participating in the conference as well as the goals or desired outcomes from the conference. In some embodiments, the system may store individualized historical information regarding the one or more users and derive user preferences based on the historical information. For instance, the user may have requested for data to be formatted in a certain font or certain layout in the past. Accordingly, the system may take into account each user's preferences when responding to queries during the conference.

Based on determining the data requirements and/or user preferences, the system may simulate the data requirements and/or user preferences to photons that may be emitted to excite the data within the relevant DNA databases. The DNA databases may comprise the databases that contain the data relevant to the conference (e.g., data regarding running processes and computing resource expenditures over time). In some embodiments, the simulation of the data requirements and/or user preferences may be accomplished through frequency modulation of the photons emitted by the system. The emission of the photons may generate cross-linkages within the data structures or data sets of the DNA based databases.

The system may then logically layer the cross-linked data into a virtualized layer that conforms to the preferences and/or data requirements as determined above. In this regard, the cross-linked data may comprise various combinations of data sets and/or perspectives of the data sets, which may include tables, charts, graphs, raw data, and/or the like. The system may then generate a data fabric based on the metadata associated with the data sets, where the data fabric may identify the various linkages and/or sublinkages within the underlying data.

Subsequently, the system may receive a request from a user for a particular view of a data set (e.g., a request for a bar graph showing the top ten resource-intensive processes that run on a continuous basis within the computing environment). In response, the system may use the data fabric to identify the data within the virtualization layer as well as any data that may be linked to the data that is needed to provide the user with the requested view or perspective of the data (e.g., the data needed to generate the bar graph). Once the data has been identified, the system may, in real-time, construct and provide a data output comprising the data set requested by the user. Furthermore, the data requirements may shift as the conference progresses. For instance, a user may edit the stated purposes or goals of the conference (e.g., the newly stated purpose may be to discuss action items with respect to cybersecurity). Upon detecting the change in data requirements, the system may dynamically adjust the data within the virtualization layer and/or the data fabric such that the data that may be needed by the users may be readily available in real time and on demand. In this way, the system may seamlessly provide the requested data to the user, thereby aiding the user in time-sensitive decision-making processes.

The system as described herein provides a number of technological benefits over conventional methods for serving data. For instance, by using the virtualization layer and data fabric in the manner described herein, the system may add an additional layer of abstraction to the data requesting process such that the end user may receive a robust data output in various different perspectives without the need for knowledge regarding the underlying data. Furthermore, the architecture described herein may allow for users to receive views and insights resulting from the underlying data without the need for access to the underlying data itself, which in turn enhances the security of the data serving process.

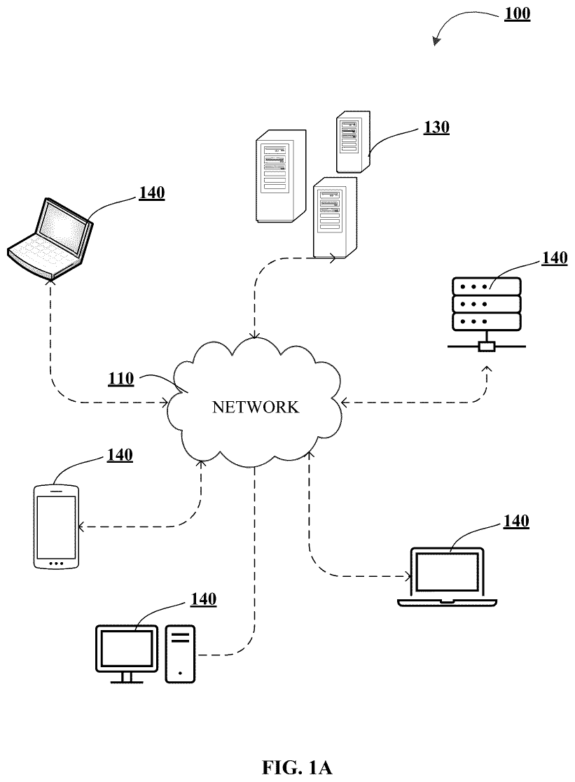

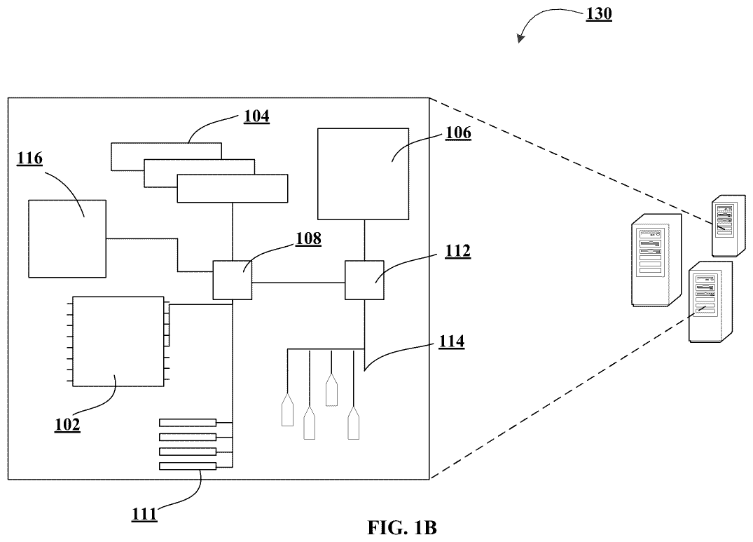

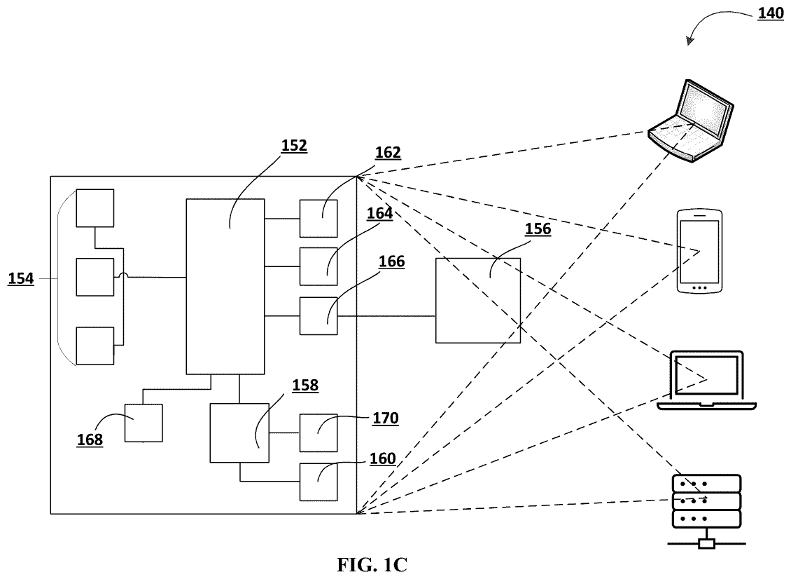

Turning now to the figures, FIGS. 1A-1C illustrate technical components of an exemplary distributed computing environment 100 for the system for generating an electronic data fabric using virtualized photocrosslinking-based parallel computing process. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned. In some embodiments, the system 130 may comprise one or more devices or elements of a DNA computing environment, which may in some embodiments include a DNA computing-based data repository or database that may comprise data expressed in a DNA format.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

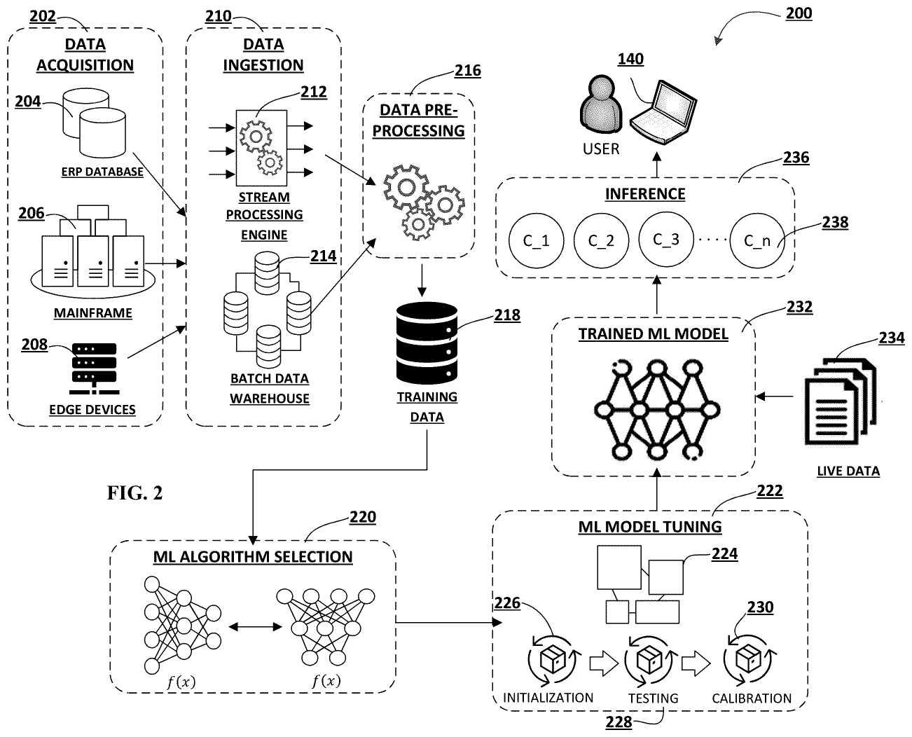

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

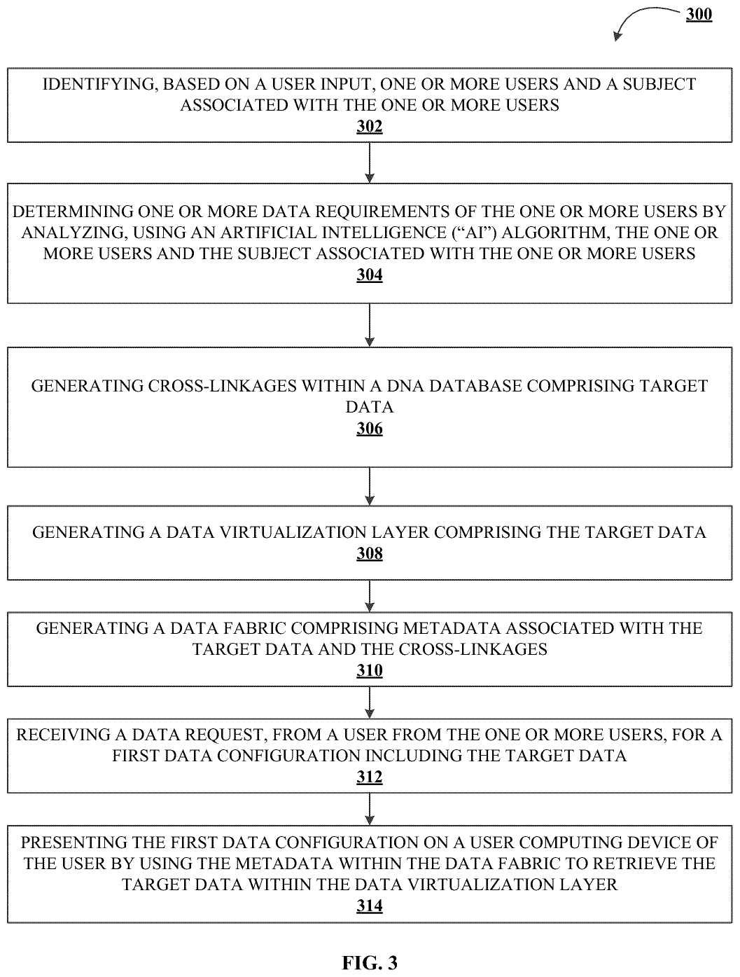

FIG. 3 illustrates a method 300 for generating an electronic data fabric using virtualized photocrosslinking-based parallel computing process. As shown in block 302, the method includes identifying, based on a user input, one or more users and a subject associated with the one or more users. In some embodiments, the user input may include a request from a user to initiate a networked conference between the one or more users, where the request to initiate the networked conference may include an identification of the one or more users, the subject, and a purpose of the conference. In this regard, the request to initiate the conference may take the form of an e-mail, instant message, teleconference meeting request, social media post, and/or the like.

Next, as shown in block 304, the method includes determining one or more data requirements of the one or more users by analyzing, using an artificial intelligence (“AI”) algorithm, the one or more users and the subject associated with the one or more users. In some embodiments, the AI algorithm may be a natural language processing (“NLP”) algorithm that uses k means clustering to parse the one or more users and the subject to identify keywords for determining the data requirements. For instance, if the subject is “Opportunities to increase energy efficiency,” the system may use the AI algorithm to identify the keywords to then determine what types of data may be required during the conference as well as the various perspectives in which the data may be optimally viewed. In some embodiments, determining the one or more data requirements may further include analyzing user preferences. For instance, the system may examine historical user input data associated with each of the one or more users to determine individual preferences (e.g., certain users may prefer the data to be formatted or displayed in a particular way). In such a scenario, the user preferences may be added to the data requirements.

Next, as shown in block 306, the method includes generating cross-linkages within a DNA database comprising target data. In this regard, generating the cross-linkages may comprise generating a stream of photons using an antenna, wherein the stream of photons simulate the one or more data requirements. In some embodiments, the system may simulate the data requirements by modulating a frequency of the photons emitted from the antenna to encode the data requirements into the stream of photons. By modulating the frequency of the stream of photons, the photons may impact the DNA database in different ways, thereby allowing for faster identification of the relevant target data.

Next, as shown in block 308, the method includes generating a data virtualization layer comprising the target data. As such, the data virtualization layer may comprise all of the target data from the DNA database that conforms to the data requirements of the one or more users and/or the conference. By generating the data virtualization layer, the system may be able to provide users with the requested data in the various requested configurations on a real-time or near real-time basis.

Next, as shown in block 310, the method includes generating a data fabric comprising metadata associated with the target data and the cross-linkages. Accordingly, generating the data fabric may comprise identifying the cross-linkages within the data virtualization layer. By identifying the target data as well as the various cross-linkages, the metadata within the data fabric may be used to quickly identify not only the core data requested from the user but also the various configurations, perspectives, and/or insights that may be generated based on the core data.

Next, as shown in block 312, the method includes receiving a data request, from a user from the one or more users, for a first data configuration including the target data. The first data configuration may, for instance, specify a format in which the target data is presented. The format may include various ways to view the target data, such as a graph format, table format, chart format, list format, and/or the like.

Next, as shown in block 314, the method includes presenting the first data configuration on a user computing device of the user by using the metadata within the data fabric to retrieve the target data within the data virtualization layer. In response to the data request, the system may identify the target data as well as the linkages by using the data fabric, and subsequently pull the target data from the data virtualization layer according to the parameters specified in the data request. Subsequently, the system may receive another (e.g., second) data request from the user or from a different user, where the second data request specifies a second data configuration including the target data (e.g., a different view or perspective of the target data). In response, the system may dynamically produce the target data in the second data configuration and present the target data to the user. In this way, the system may efficiently and dynamically serve the data needs of users on a real-time basis.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating an electronic data fabric using virtualized photocrosslinking-based parallel computing process, the system comprising:
a processing device;
a non-transitory storage device containing instructions when executed by the processing device, causes the processing device to perform the steps of:
identifying, based on a user input, one or more users and a subject associated with the one or more users;
determining one or more data requirements of the one or more users by analyzing, using an artificial intelligence (“AI”) algorithm, the one or more users and the subject associated with the one or more users;
generating cross-linkages within a DNA database comprising target data;
generating a data virtualization layer comprising the target data;
generating a data fabric comprising metadata associated with the target data and the cross-linkages;
receiving a data request, from a user from the one or more users, for a first data configuration including the target data; and
presenting the first data configuration on a user computing device of the user by using the metadata within the data fabric to retrieve the target data within the data virtualization layer.

2. The system of claim 1, wherein generating the cross-linkages comprises generating a stream of photons using an antenna, wherein the stream of photons simulate the one or more data requirements.

3. The system of claim 2, wherein generating the stream of photons comprises modulating a frequency of the photons emitted from the antenna to encode the data requirements into the stream of photons.

4. The system of claim 1, wherein the AI algorithm comprises a natural language processing based algorithm that uses k-means clustering to identify keywords associated with the one or more users and the subject associated with the one or more users.

5. The system of claim 1, wherein the user input comprises a request to initiate a networked conference including the one or more users.

6. The system of claim 5, wherein the request to initiate the networked conference comprises a description of a purpose of the conference, wherein determining the data requirements further comprises using the AI algorithm to analyze the description of the purpose of the conference.

7. The system of claim 1, wherein the first data configuration comprises at least one of a chart, graph, table, or list generated based on the target data.

8. A computer program product for generating an electronic data fabric using virtualized photocrosslinking-based parallel computing process, the computer program product comprising a non-transitory computer-readable medium comprising code causing an apparatus to perform the steps of:
identifying, based on a user input, one or more users and a subject associated with the one or more users;
determining one or more data requirements of the one or more users by analyzing, using an artificial intelligence (“AI”) algorithm, the one or more users and the subject associated with the one or more users;
generating cross-linkages within a DNA database comprising target data;
generating a data virtualization layer comprising the target data;
generating a data fabric comprising metadata associated with the target data and the cross-linkages;
receiving a data request, from a user from the one or more users, for a first data configuration including the target data; and
presenting the first data configuration on a user computing device of the user by using the metadata within the data fabric to retrieve the target data within the data virtualization layer.

9. The computer program product of claim 8, wherein generating the cross-linkages comprises generating a stream of photons using an antenna, wherein the stream of photons simulate the one or more data requirements.

10. The computer program product of claim 9, wherein generating the stream of photons comprises modulating a frequency of the photons emitted from the antenna to encode the data requirements into the stream of photons.

11. The computer program product of claim 8, wherein the AI algorithm comprises a natural language processing based algorithm that uses k-means clustering to identify keywords associated with the one or more users and the subject associated with the one or more users.

12. The computer program product of claim 8, wherein the user input comprises a request to initiate a networked conference including the one or more users.

13. The computer program product of claim 12, wherein the request to initiate the networked conference comprises a description of a purpose of the conference, wherein determining the data requirements further comprises using the AI algorithm to analyze the description of the purpose of the conference.

14. A computer-implemented method for generating an electronic data fabric using virtualized photocrosslinking-based parallel computing process, the computer-implemented method comprising:
identifying, based on a user input, one or more users and a subject associated with the one or more users;
determining one or more data requirements of the one or more users by analyzing, using an artificial intelligence (“AI”) algorithm, the one or more users and the subject associated with the one or more users;
generating cross-linkages within a DNA database comprising target data;
generating a data virtualization layer comprising the target data;
generating a data fabric comprising metadata associated with the target data and the cross-linkages;
receiving a data request, from a user from the one or more users, for a first data configuration including the target data; and
presenting the first data configuration on a user computing device of the user by using the metadata within the data fabric to retrieve the target data within the data virtualization layer.

15. The computer-implemented method of claim 14, wherein generating the cross-linkages comprises generating a stream of photons using an antenna, wherein the stream of photons simulate the one or more data requirements.

16. The computer-implemented method of claim 15, wherein generating the stream of photons comprises modulating a frequency of the photons emitted from the antenna to encode the data requirements into the stream of photons.

17. The computer-implemented method of claim 14, wherein the AI algorithm comprises a natural language processing based algorithm that uses k-means clustering to identify keywords associated with the one or more users and the subject associated with the one or more users.

18. The computer-implemented method of claim 14, wherein the user input comprises a request to initiate a networked conference including the one or more users.

19. The computer-implemented method of claim 18, wherein the request to initiate the networked conference comprises a description of a purpose of the conference, wherein determining the data requirements further comprises using the AI algorithm to analyze the description of the purpose of the conference.

20. The computer-implemented method of claim 14, wherein the first data configuration comprises at least one of a chart, graph, table, or list generated based on the target data.
